(19) United States
(12) Patent Application Publication
(10) Pub. No.: US 2006/0028260 A1
(43) Pub. Date: Feb. 9, 2006

(54) Logarithmic amplifier with base and emitter in feedback path

(76) Inventor: Richard A. Baumgartner, Palo Alto, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/911,369

(22) Filed: Aug. 4, 2004

(51) Int. Cl. G06G 7/24

(52) U.S. Cl. 327/350

(57) ABSTRACT

A logarithmic amplifier includes the base and emitter of a bipolar junction transistor coupled in a feedback path between the output and the input of a gain element. When the bipolar junction transistor is a PNP transistor, the logarithmic amplifier can be made compatible with CMOS semiconductor circuitry and processes.

### BACKGROUND OF THE INVENTION

Logarithmic amplifiers are used in a variety of measurement applications to amplify signals that span wide dynamic ranges. For example, logarithmic amplifiers disclosed in U.S. Pat. No. 4,996,500 are coupled to detectors in an automatic level control system to amplify signals from the detectors that span multiple voltage decades. The logarithmic amplifiers provide nonlinear amplification, where the amount of amplification depends on the magnitude of the signals that are applied to the logarithmic amplifiers. Higher amplification is provided to an applied signal that has a lower magnitude, and lower amplification is provided to an applied signal that has a higher magnitude.

A conventional logarithmic amplifier, disclosed in engineering texts such as Analysis and Design of Analog Integrated Circuits, Second Edition, by Gray and Meyer, ISBN 0471-87493-0, page 358, includes a voltage amplifier with the collector and emitter of a bipolar junction transistor coupled in a feedback path between the input and output of the voltage amplifier, as shown in FIG. 1. These logarithmic amplifiers can be implemented in a variety ways. In one implementation, the voltage amplifier and bipolar junction transistor are integrated using bipolar semiconductor processes to form an integrated circuit. In another implementation, the voltage amplifier is an operational amplifier and the bipolar junction transistor, such as an NPN transistor, is a discrete device that is external to the operational amplifier. However, in a variety of measurement systems, signal processing circuitry is implemented using CMOS semiconductor processes, due to the low cost and high levels of integration that can be achieved using the CMOS semiconductor processes. The logarithmic amplifier of FIG. 1 is not compatible with circuitry implemented in the CMOS semiconductor process because the collector of a bipolar junction transistor fabricated in the CMOS semiconductor process is formed in the semiconductor substrate, which during operation of the circuitry is tied to the lowest potential provided to the circuitry. Since in many measurement systems it is desirable to integrate a logarithmic amplifier with other circuitry implemented using CMOS semiconductor processes, there is a need for a logarithmic amplifier that is compatible with CMOS semiconductor processes.

### SUMMARY OF THE INVENTION

A logarithmic amplifier according to embodiments of the present invention includes the base and emitter of a bipolar junction transistor coupled in a feedback path between the output and the input of a gain element. When the bipolar junction transistor is a PNP transistor, the logarithmic amplifier can be made compatible with CMOS semiconductor circuitry and processes.

### BRIEF DESCRIPTION OF THE DRAWINGS

FIG. 1 shows a conventional logarithmic amplifier.

FIGS. 2A-2D show logarithmic amplifiers according to embodiments of the present invention.

FIG. 3 shows a logarithmic amplifier according to alternative embodiments of the present invention.

FIGS. 4A-4B show exemplary transfer characteristics for the logarithmic amplifier shown in FIG. 3.

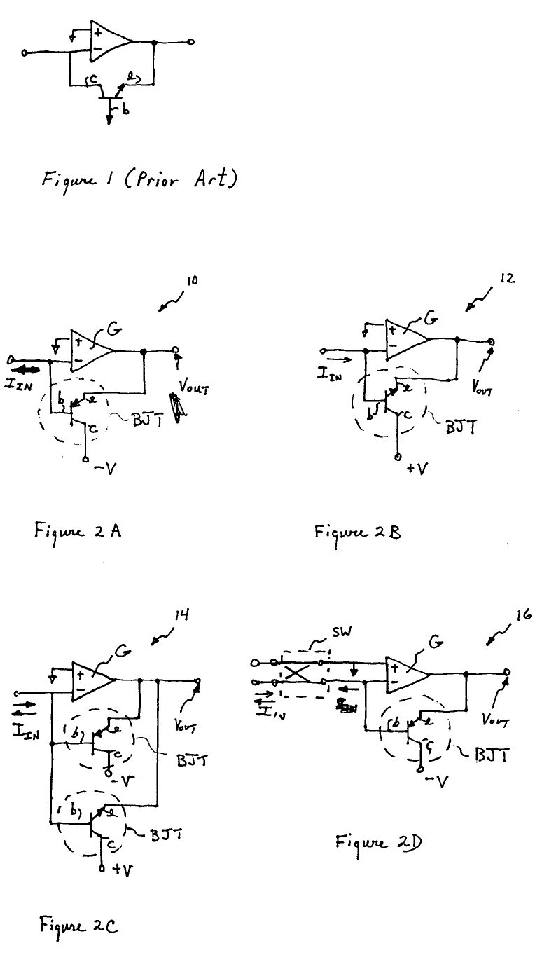

### DETAILED DESCRIPTION OF THE EMBODIMENTS

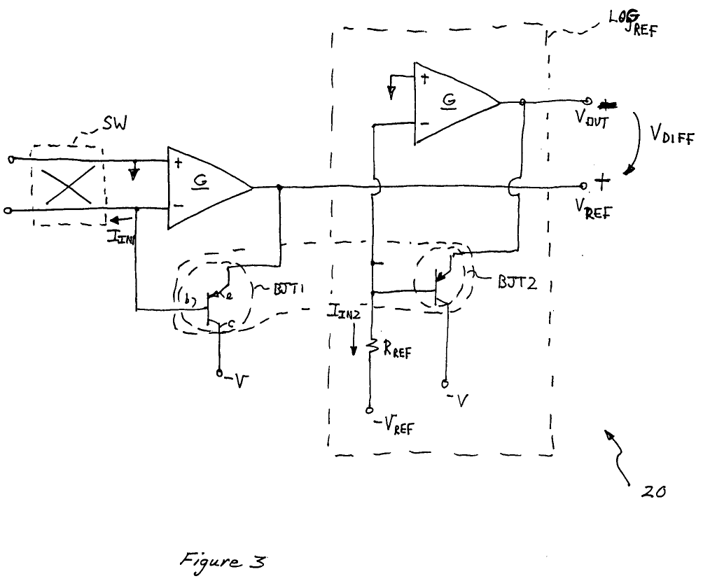

FIGS. 2A-2D show logarithmic amplifiers 10, 12, 14, 16 according to first embodiments of the present invention. The logarithmic amplifiers 10, 12, 14, 16 each include a gain element G, which can be any of a variety of amplifiers that provide high open-loop gain. Typically, the gain element G is an integrated semiconductor amplifier, such as an operational amplifier, or an amplifier implemented using discrete components. The exemplary logarithmic amplifiers shown in FIGS. 2A-2D include differential voltage amplifiers, having high open-loop gain, as the gain element G. The voltage amplifiers have inverting inputs labeled “−” and have noninverting inputs labeled “+”.

Each of the logarithmic amplifiers 10, 12, 14, 16 also include one or more bipolar junction transistors BJT. The base b and the emitter e of the bipolar junction transistors BJT are coupled in feedback paths of the logarithmic amplifiers 10, 12, 14, 16 between an output and an input of the gain element G. In the example shown, the base b of the bipolar junction transistor BJT is coupled to the inverting input of the gain element G, and the emitter e of the bipolar junction transistor BJT is coupled to the output of the gain element G. In the embodiment of the present invention shown in FIG. 2A, the bipolar junction transistor BJT is a PNP transistor. In one example of this embodiment, the gain element G and the PNP transistor are integrated using a CMOS semiconductor process, which enables the logarithmic amplifier 10 to be integrated within a CMOS integrated circuit. The collector c of the BJT is typically formed in the substrate of a CMOS integrated circuit and tied to a negative supply voltage −v during operation of the logarithmic amplifier 10. In other examples of this embodiment, the PNP transistor and the gain element G are integrated into other types of integrated circuits, or the PNP transistor and the gain element G are not integrated.

In an embodiment of the present invention shown in FIG. 2B, the bipolar junction transistor BJT included in the logarithmic amplifier 12 is an NPN transistor. In this embodiment, the collector c of the NPN transistor is typically tied to a positive supply voltage +v during operation of the logarithmic amplifier 12.

In other embodiments of the present invention, shown in FIG. 2C-2D, the logarithmic amplifiers 14, 16 are configured to accommodate applied currents I_{IN} of both polarities. For example, the logarithmic amplifier 14 in FIG. 2C includes the base b and emitter e of both an NPN transistor and a PNP transistor coupled in a parallel arrangement in the feedback path between the output and the input of the gain element G. The logarithmic amplifier 16 in FIG. 2D includes an input polarity switch SW that is set according to the polarity of the applied signal to provide the current I_{IN} of the appropriate polarity for the type of bipolar junction transistor BJT included in the logarithmic amplifier 16.

The logarithmic amplifiers 10, 12, 14, 16 typically include a feedback capacitor (not shown) in the feedback path between the output and the input of the gain element G, to maintain stable operation of the logarithmic amplifier over a range of operating conditions. The value of the feedback capacitor can be determined empirically or can be determined analytically, for example based on the gain transfer characteristics of the gain element and the junction capacitances of the bipolar junction transistor BJT.

Equation 1 indicates the transfer characteristic of the logarithmic amplifiers 10, 12, 14, 16 of FIGS. 2A-2D, illustrating the relationship between input currents I_{IN} applied to the logarithmic amplifiers and output voltages V_{OUT} provided by the logarithmic amplifiers 10, 12, 14, 16 in response to the input currents I_{IN}.
V_{OUT}=(kT/q)ln(BI_{IN}/I_{SAT}) (1)
In equation 1, kT/q is the known term V_{T}, which is equal to 26 mV at 300 degrees Kelvin. The term B is the current gain of the bipolar junction transistor BJT, and the term I_{SAT} is the saturation current of the bipolar junction transistor BJT.

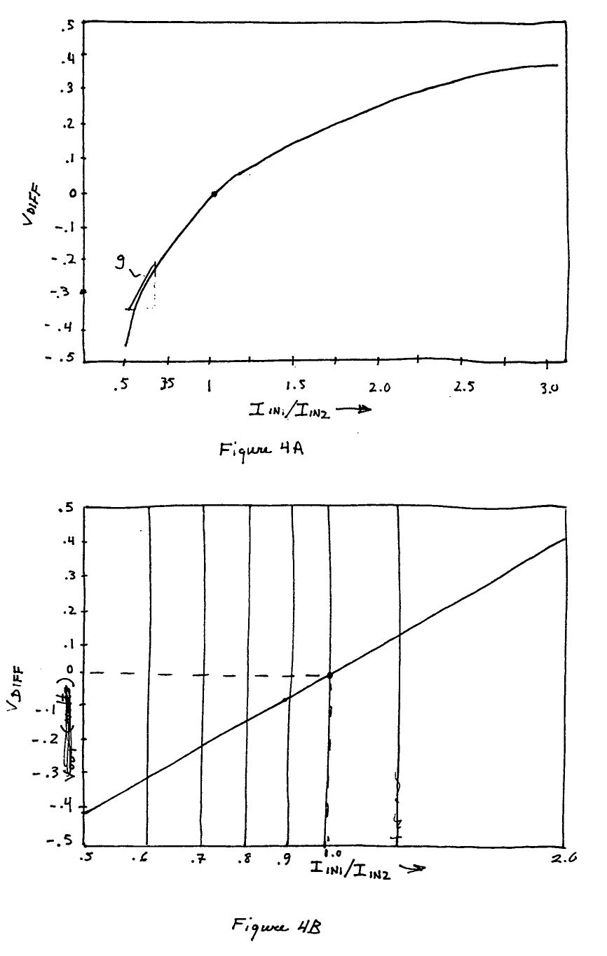

To achieve a transfer characteristic that is independent of transistor parameters such as the term B and the term I_{SAT}, a reference logarithmic amplifier LOG_{REF} can be included with the logarithmic amplifiers 10, 12, 14, 16 of FIGS. 2A-2D to form a differential logarithmic amplifier 20, as shown in the alternative embodiment of the present invention of FIG. 3. In this embodiment, the differential logarithmic amplifier 20 provides an output voltage V_{DIFF}, as indicated in equation 2.
V_{DIFF}=V_{REF}−V_{OUT}=(kT/q)(ln(B₁I_{IN1}/I_{SAT1})−ln(B₂I_{IN2}/I_{SAT2})) (2)
In equation 2, the voltage V_{REF} represents a reference output voltage provided by the reference logarithmic amplifier LOG_{REF}. The term B₁ is the current gain of the bipolar junction transistor BJT₁, the term B₂ is the current gain of the reference bipolar junction transistor BJT₂, the term I_{SAT1} is the saturation current of the bipolar junction transistor BJT₁, and the term I_{SAT2} is the saturation current of the reference bipolar junction transistor BJT₂. When the bipolar junction transistor BJT₁ and the reference bipolar transistor BJT₂ in the differential logarithmic amplifier 20 are integrated or commonly fabricated, or otherwise have matched parameters, the current gains B₁ and B₂ are approximately equal, and I_{SAT1} and I_{SAT2} are approximately equal. Assuming that B₁=B₂, and that I_{SAT1}=I_{SAT2}, the output voltage V_{DIFF} is independent of these transistor parameters as indicated in equation 3.
V_{DIFF}=V_{REF}−V_{OUT}=(kT/q)ln(I_{IN1}/I_{IN2}) (3)
Because the output voltage V_{DIFF} is proportional to the logarithm of the ratio of the input current I_{IN1} to the current I_{IN2}, the current I_{IN2} can be adjusted via R_{REF} or V_{REF} as a reference current that is used to set the gain G of the differential logarithmic amplifier 20. An optionally included input polarity switch SW is shown included in the differential logarithmic amplifier 20 in FIG. 3.

FIGS. 4A-4B show exemplary transfer characteristics of the differential logarithmic amplifier 20. In FIG. 4A, the output voltage V_{DIFF} is indicated versus the ratio of currents I_{IN1}/I_{IN2} on a linear scale. In FIG. 4B, the output voltage V_{DIFF} is indicated versus the ratio of currents I_{IN1}/I_{IN2} on a logarithmic scale. The gain g of the differential logarithmic amplifier 20, indicated by the slope of the transfer characteristics in FIGS. 4A-4B, depends on the ratio of the currents I_{IN1}/I_{IN2}. When the input current I_{IN1} is low relative to the reference current I_{IN2}, the gain of the logarithmic amplifier is higher than when the input current I_{IN1} is high relative to the reference current I_{IN2}.

Once the reference current I_{IN2} is set, the gain g of the differential logarithmic amplifier 20 adjusts automatically based on the magnitude of the input current I_{IN1}. This makes the differential logarithmic amplifier 20 well-suited to amplify applied signals over a wide dynamic range. Relatively low-level input currents I_{IN1} provide high resistance in the feedback path between the output and the input of the gain element, resulting in relatively high gain. Relatively high-level input currents provide low resistance in the feedback path, resulting in relatively low gain.

The nonlinear transfer characteristic of the logarithmic amplifier 20 provides a gain g at a given ratio of currents I_{IN1}/I_{IN2} that is eqivalent to a gain that can be provided by an amplifier with a variable resistor in the feedback path between the output and the input of the gain element G. However, the performance of the differential logarithmic amplifier 20 is distinguished from an amplifier with a variable resistor in the feedback path. For example, when the differential logarithmic amplifier 20 has a gain g equivalent to that of an amplifier with a 2.512 Mohm resistor in the feedback path, the differential logarithmic amplifier 20 has approximately three times the bandwidth of the resistive amplifier. For example, the differential logarithmic amplifier 20 has a 1 MHz bandwidth, whereas the amplifier with the 2.512 Mohm resistor in the feedback path has a 317 KHz bandwidth. The differential logarithmic amplifier 20 also has a lower noise density, for example 56.6 fA/Hz^{1/2}, than the amplifier with the 2.512 Mohm resistor in the feedback path, which has for example, a noise density of 75 fA/Hz^{1/2}.

While the embodiments of the present invention have been illustrated in detail, it should be apparent that modifications and adaptations to these embodiments may occur to one skilled in the art without departing from the scope of the present invention as set forth in the following claims.

1. An amplifier, comprising:
a gain element; and
a bipolar junction transistor having an emitter coupled to an output of the gain element and having a base coupled to an input of the gain element.

2. The amplifier of claim 1 wherein the gain element is a voltage amplifier and the base of the bipolar junction transistor is coupled to an inverting input of the voltage amplifier, and wherein the base receives an applied current and the gain element provides an output voltage in response to the applied current.

3. The amplifier of claim 1 wherein the bipolar junction transistor is a PNP transistor.

4. The amplifier of claim 2 wherein the bipolar junction transistor is a PNP transistor.

5. The amplifier of claim 3 wherein the gain element and the bipolar junction transistor are integrated into a CMOS integrated circuit.

6. The amplifier of claim 4 wherein the gain element and the bipolar junction transistor are integrated into a CMOS integrated circuit.

7. The amplifier of claim 1 wherein the bipolar junction transistor is an NPN transistor.

8. The amplifier of claim 2 wherein the bipolar junction transistor is an NPN transistor.

9. The amplifier of claim 2 further comprising a reference logarithmic amplifier including a reference bipolar junction transistor having parameters matched to the bipolar junction transistor, the reference logarithmic amplifier providing a reference current and providing a reference output, wherein the difference between the output of the gain element and the reference output is proportional to the logarithm of the ratio of the applied current to the reference current.

10. The amplifier of claim 9 wherein the bipolar junction transistor is a PNP transistor and the reference bipolar junction transistor is a PNP transistor.

11. The amplifier of claim 9 wherein the gain element and the bipolar junction transistor and the reference logarithmic amplifier are integrated into a CMOS integrated circuit.

12. The amplifier of claim 10 wherein the gain element and the bipolar junction transistor and the reference logarithmic amplifier are integrated into a CMOS integrated circuit.

13. The amplifier of claim 9 wherein the bipolar junction transistor is an NPN transistor and the reference bipolar junction transistor is an NPN transistor.
